(19) United States
(12) Patent Application Publication
(10) Pub. No.: US 2023/0030853 A1
(43) Pub. Date: Feb. 2, 2023

(54) AIRCRAFT PROPULSION ASSEMBLY HAVING A JET ENGINE, A PYLON AND MEANS FOR ATTACHING THE JET ENGINE TO THE PYLON

(71) Applicant: Airbus Operations SAS, Toulouse (FR)

(72) Inventors: Paolo MESSINA, TOULOUSE (FR); Olivier PAUTIS, TOULOUSE (FR)

(21) Appl. No.: 17/868,161

(22) Filed: Jul. 19, 2022

(30) Foreign Application Priority Data
Jul. 28, 2021 (FR) 2108191

(51) Int. Cl. B64D 27/18

(52) U.S. Cl. CPC B64D 27/18; B64D 2027/268

(57) ABSTRACT

A propulsion assembly having a jet engine with a central casing, an attachment pylon having a rigid structure, a front engine attachment and a device for reacting the thrust forces. The front engine attachment has, on either side of a median plane, a front rod articulated via a connection point respectively to the rigid structure and to the central casing, and the reaction device has two central rods, two first fittings as one with the rigid structure and two second fittings as one with the central casing, wherein the two first fittings are independent of one another and wherein each central rod is articulated between a first fitting and a second fitting.

### CROSS-REFERENCES TO RELATED APPLICATIONS

This application claims the benefit of the French patent application No. 2108191 filed on Jul. 28, 2021, the entire disclosures of which are incorporated herein by way of reference.

### FIELD OF THE INVENTION

The present invention relates to the general field of attaching a jet engine beneath the wing of an aircraft. It relates, in particular, to a propulsion assembly comprising a jet engine, in particular a turbofan, a pylon and also an attachment device intended to attach the jet engine beneath the pylon. It also relates to an aircraft equipped with such a propulsion assembly.

### BACKGROUND OF THE INVENTION

A propulsion assembly of the prior art is fastened beneath a wing of an aircraft that has a jet engine and an attachment pylon via which the jet engine is fastened beneath the wing. Generally, the attachment pylon has a rigid structure, which is also called the primary structure, bearing first fastening elements intended to attach the jet engine.

These first fastening elements are formed of a front engine attachment, a rear engine attachment, and a device for reacting the thrust forces generated by the jet engine.

The attachment pylon also has second fastening elements allowing the attachment pylon to be fastened to the wing.

The jet engine has, at the front, a fan casing surrounding an annular fan duct and, towards the rear, a central casing of smaller size, enclosing the core of the jet engine.

The front engine attachment is interposed between a front end of the rigid structure and a front upper part of the central casing, and the rear engine attachment is interposed between the rigid structure and a rear upper part of the central casing. The device for reacting the thrust forces generated by the jet engine comprises two rods disposed on either side of a median vertical plane of the jet engine and articulated, on the one hand, on the central casing, and, on the other hand, on a single spreader fastened to the rigid structure. The device for reacting the thrust forces that is formed by the two rods and the spreader is designed to react all or most of the forces oriented in the longitudinal direction X of the jet engme.

The front engine attachment has, on either side of the pylon, a rod and each rod is fastened in an articulated manner to the pylon by one of its ends and is fastened in an articulated manner to the central casing by the other of its ends. One of the rods is fastened via two connection points to the pylon and via one connection point to the central casing, and the second rod is fastened via a connection point to the pylon and via a connection point to the central casing.

The front engine attachment makes it possible to react some of the forces oriented in the directions Y and Z and a torsional moment Mx. The rear engine attachment also makes it possible to react some of the forces oriented in the directions Y and Z.

Although such a structure is satisfactory, it is desirable to find an arrangement that allows a different reaction of the forces in particular at the front engine attachment and at the device for reacting the thrust forces.

### SUMMARY OF THE INVENTION

An object of the present invention is to propose a propulsion assembly comprising a jet engine, a pylon and an attachment device intended to attach the jet engine beneath the pylon, and that allows a different redistribution of the force reactions.

To that end, there is proposed a propulsion assembly for an aircraft, said propulsion assembly having:

a jet engine having a central casing around a longitudinal axis and having a vertical median plane passing through the longitudinal axis,

an attachment pylon having a rigid structure that takes the form of a box that has a lower wall, an upper wall, two lateral walls and a frontal wall,

a front engine attachment,

a rear engine attachment interposed between a median zone of the rigid structure and a rear upper part of the central casing, and

a device for reacting the thrust forces generated by the jet engine,

wherein the front engine attachment has, on either side of the median plane, a front rod and each front rod is fastened in an articulated manner via a connection point to a front end of the rigid structure and via a connection point to a front fitting as one with an upper part of the central casing, and

wherein the device for reacting the thrust forces of the jet engine has two central rods disposed on either side of the median plane, for each central rod, a first fitting as one with the rigid structure and a second fitting as one with a front part of the central casing, wherein the two first fittings are independent of one another, wherein each central rod is fastened in an articulated manner via one of its ends to the first fitting and via the other of its ends to the second fitting and wherein the rear engine attachment has a rear rod fastened in an articulated manner via two connection points to a rear fitting as one with the central casing and via one connection point to an upper fitting as one with the rigid structure,

the propulsion assembly being characterized in that each first fitting is fastened to one of the lateral walls of the rigid structure.

With such an arrangement, the forces are reacted in pairs at different planes.

The invention also proposes an aircraft having a wing and a propulsion assembly according to the preceding variant, of which the rigid structure is fastened beneath the wing.

### BRIEF DESCRIPTION OF THE DRAWINGS

The abovementioned features of the invention, along with others, will become more clearly apparent upon reading the following description of one exemplary embodiment, said description being given with reference to the appended drawings, in which:

FIG. 1 shows a side view of an aircraft according to the invention,

FIG. 2 is a perspective view of a propulsion assembly according to the invention, and

FIG. 3 is an enlarged view of the front engine attachment in FIG. 2.

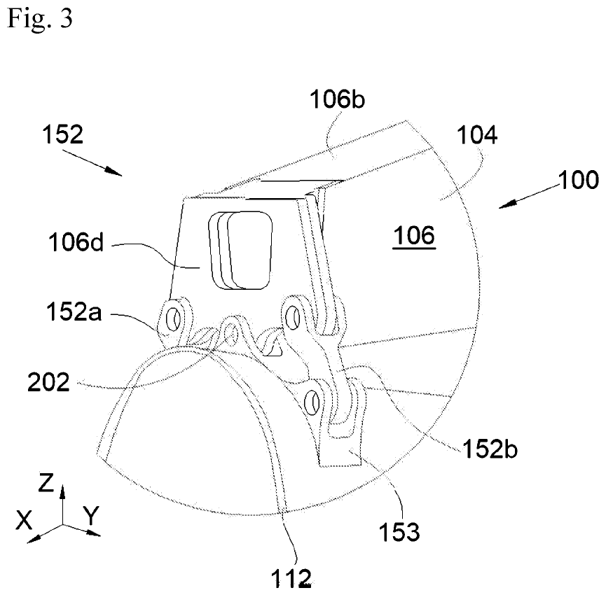

### DETAILED DESCRIPTION OF THE PREFERRED EMBODIMENTS

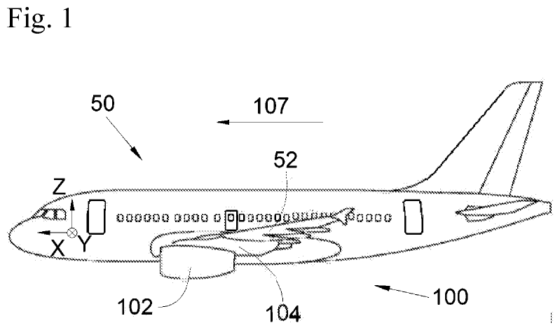

FIG. 1 shows an aircraft 50 that has a wing 52 beneath which is mounted a propulsion assembly 100 that has a jet engine 102 and an attachment pylon 104.

By convention, X denotes the longitudinal direction of the jet engine 102, this direction X being parallel to a longitudinal axis of this jet engine 102. Moreover, Y denotes the transverse direction of the jet engine 102, this direction being horizontal when the aircraft is on the ground, and Z denotes the vertical direction or vertical height when the aircraft is on the ground, these three directions X, Y and Z being mutually orthogonal.

Moreover, the terms “front” and “rear” are to be considered relative to a direction of forward movement of the aircraft when the jet engine 102 is in operation, this direction being schematically shown by the arrow 107.

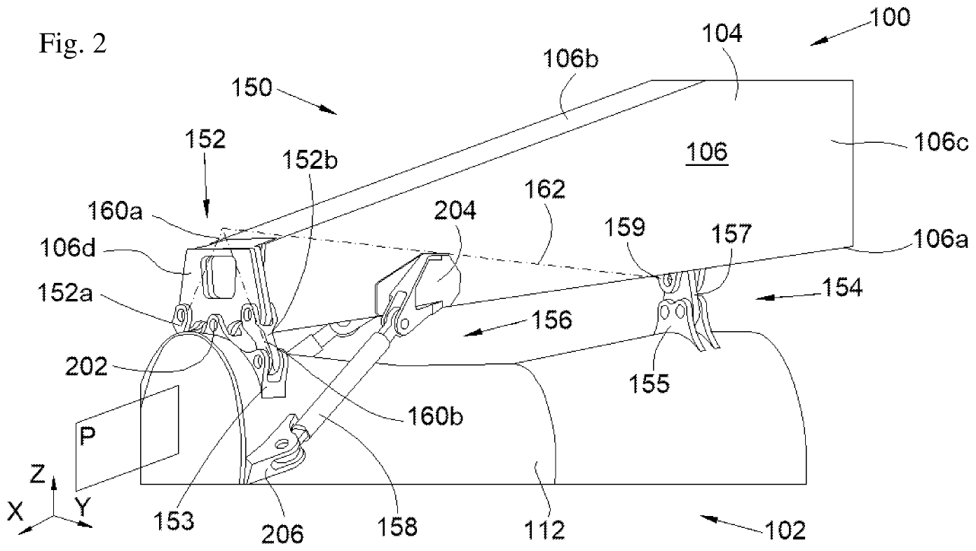

FIG. 2 shows the propulsion assembly 100 that has the jet engine 102 and the attachment pylon 104 via which the jet engine 102 is fastened to the wing 52. The attachment pylon 104 is shown here by its rigid structure 106, which is also called the primary structure, bearing first fastening elements 150 intended to attach the jet engine 102. The rigid structure 106 extends in the longitudinal direction X between a front end and a rear end, between which there is a median zone.

In the embodiment of the invention that is presented in FIG. 2, the rigid structure 106 takes the form of a box that has a lower wall 106a, an upper wall 106b, two lateral walls 106c and a frontal wall 106d.

These first fastening elements are formed of a front engine attachment 152, a rear engine attachment 154, and a reaction device 156 for reacting the thrust forces generated by the jet engine 102.

The attachment pylon 104 also has second fastening elements allowing the attachment pylon 104, and more particularly the rigid structure 106, to be fastened to the wing 52. The second fastening elements are not shown in the figures, since they are outside the boundaries of the invention and can take any form known to those skilled in the art.

The jet engine 102 has, at the front, a fan casing surrounding an annular fan duct (also not shown here) and, inside and towards the rear of the fan casing, a central casing 112 of smaller size, enclosing the core of the jet engine 102 about a longitudinal axis.

The front engine attachment 152 is interposed directly between a front end of the rigid structure 106, in this case the frontal wall 106d, and a front upper part of the central casing 112 via a front fitting 153 as one with said front upper part of the central casing 112, said upper part being at a vertical median plane XZ of the jet engine 102 that passes through the longitudinal axis of the jet engine 102 and that is called median plane P below.

The attachment pylon 104 is, overall, symmetric with respect to the median plane P.

The rear engine attachment 154 is interposed directly between the median zone of the rigid structure 106, in this case the lower wall 106a, and a rear fitting 155 as one with a rear upper part of the central casing 112.

The reaction device 156 comprises two central rods 158 disposed on either side of the median plane P and articulated, on the one hand, at the front, on a front part of the central casing 112, and, on the other hand, at the rear, on the rigid structure 106 between the front end and the median zone.

The front engine attachment 152 has, on either side of the median plane P, a front rod 152a-b and each front rod 152a-b is fastened in an articulated manner via one of its ends to the front end of the rigid structure 106, in this case the frontal wall 106d, and is fastened in an articulated manner via the other of its ends to the front fitting 153.

In the embodiment of the invention, each front rod 152a-b is a rod with two fastening points and is fastened via a single connection point to the rigid structure 106 and via a single connection point to the front fitting 153.

In the embodiment of the invention that is presented here, for each front rod 152a-b, each point of connection to the rigid structure 106 and to the front fitting 153 is made up of a female clevis created, respectively, in the front rod 152a-b and in the front fitting 153, a male clevis created, respectively, by the rigid structure 106 and the front rod 152a-b and a shear pin, for example a single shear pin, which passes through the female clevis and fits in the male clevis via a ball joint.

As a result of the presence of a single connection point at the end of each front rod 152a-b, each front rod 152a-b makes it possible to react a force along said front rod 152a-b and this force has components in the Y and Z directions in a frontal plane perpendicular to the longitudinal direction X and containing the four connection points of the front rods 152a-b. The front fitting 153 and the front rods 152a-b define a primary force path.

Such an arrangement also prevents the occurrence of a moment Mx at the frontal plane and this makes it possible to have elements that are more lightweight and less expensive.

The direction of the force along the front rod 152a is shown by the line 160a and the direction of the force along the front rod 152b is shown by the line 160b and these two straight lines are in the frontal plane and converge at a point of intersection.

For safety reasons, the front engine attachment 152 has an additional connection point 202 disposed centrally on the median plane P and provides an additional connection between the rigid structure 106 and to the front fitting 153. The additional connection point 202 takes the form of a backup safety fastening point (or “waiting fail-safe”) that compensates a failure of the primary force path, i.e., of at least one of the front rods 152a-b.

The backup safety fastening point 202 is made up for example of a female clevis created in the front fitting 153, a male clevis created by the frontal wall 106d of the rigid structure 106 and a pin that is fitted in said female clevis and that passes through the male clevis through a bore provided for this purpose and of which the diameter is greater than the diameter of the pin. Thus, in normal operation there is no contact between the pin and the frontal wall 106d of the rigid structure 106, and in the event of one of the front rods 152a-b breaking, the central casing 112 would move and the pin would then come into contact with the frontal wall 106d of the rigid structure 106.

The rear engine attachment 154 has a rear rod 157 fastened in an articulated manner to the rear fitting 155 and to an upper fitting 159 as one with the rigid structure 106, in this case with the lower wall 106a.

In the embodiment of the invention, the rear rod 157 is a rod with three fastening points and is fastened via a connection point to the upper fitting 159 and via two connection points to the rear fitting 155.

In the embodiment of the invention that is presented here, each point of connection of the rear rod 157 to the upper fitting 159 and to the rear fitting 155 is made up of a female clevis created in the fittings 155 and 159, a male clevis made up of the rear rod 157 and a shear pin, for example a single shear pin, which passes through the female clevis and fits in the male clevis in a bore of the rear rod 157 provided for this purpose via a ball joint. For the backup safety fastening point 202, the shear pin is preferentially a double pin.

The rear rod 157 makes it possible to react forces in the Z direction and in the Y direction in a rear plane perpendicular to the longitudinal direction X and containing the three connection points of the rear rod 157.

The line 162 passing respectively through the point of intersection of the two axes 160a-b of the front rods 152a-b and the center of the point of connection of the rear rod 157 to the upper fitting 159 is a swing line.

The reaction device 156 has, for each central rod 158, a first fitting 204 as one with the rigid structure 106 and a second fitting 206 as one with the central casing 112.

The two first fittings 204 are independent of one another and each first fitting 204 is fastened on one of the sides of the rigid structure 106 to one of the lateral walls 106c.

Each central rod 158 is fastened in an articulated manner via one of its ends to the first fitting 204 and via the other of its ends to the second fitting 206. Each central rod 158 is thus fastened via a connection point to the first fitting 204 and via a connection point to the second fitting 206.

In the embodiment of the invention that is presented here, each point of connection of a central rod 158 to the fittings 204 and 206 is made up of a female clevis created, respectively, in the fittings 204 and 206, a male clevis created by the central rod 158 at each of its ends and a shear pin, for example a single shear pin, which passes through the female clevis and fits in the male clevis in a bore of the central rod 158 provided for this purpose via a ball joint.

As a result of the separation of the first fittings 204, each central rod 158 makes it possible to react a force along the central rod 158 and this force has components in the X, Y and Z directions in a central plane perpendicular to the longitudinal direction X and containing the two points of connection of the central rods 158 to the first fittings 204.

At each of the frontal, rear and central planes, the first fastening elements 150 make it possible to react two forces at each plane and therefore allow better distribution of the loads.

The moment Mx is compensated for by the forces in the two central rods 158 and the forces in the Y direction on the swing line 162 at the frontal plane and the rear plane.

The moment My is compensated for by the forces in the Z direction at the three planes and the forces in the X direction along the two central rods 158.

The moment Mz is compensated for by the forces in the Y direction at the frontal plane YZ and median vertical plane XZ at the front engine attachment 152 and the forces in the X direction along the two central rods 158.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A propulsion assembly for an aircraft, said propulsion assembly comprising:
a jet engine having a central casing around a longitudinal axis and having a vertical median plane passing through the longitudinal axis,
an attachment pylon having a rigid structure that is formed as a box that has a lower wall, an upper wall, two lateral walls and a frontal wall,
a front engine attachment,
a rear engine attachment interposed between a median zone of the rigid structure and a rear upper part of the central casing, and
a device for reacting thrust forces generated by the jet engine,
wherein the front engine attachment has, on either side of the median plane, a front rod and each front rod is fastened in an articulated manner via a connection point to a front end of the rigid structure and via a connection point to a front fitting as one with an upper part of the central casing,
wherein the device for reacting the thrust forces of the jet engine has two central rods disposed on either side of the median plane, for each central rod, a first fitting as one with the rigid structure and a second fitting as one with a front part of the central casing,
wherein the two first fittings are independent of one another,
wherein each central rod is fastened in an articulated manner via one of its ends to the first fitting and via the other of its ends to the second fitting,
wherein the rear engine attachment has a rear rod fastened in an articulated manner via two connection points to a rear fitting as one with the central casing and via one connection point to an upper fitting as one with the rigid structure, and
wherein each first fitting is fastened to one of the lateral walls of the rigid structure.

2. An aircraft having a wing and a propulsion assembly according to claim 1, wherein the rigid structure is fastened beneath the wing.
